(19) United States
(12) Patent Application Publication
(10) Pub. No.: US 2010/0175521 A1
(43) Pub. Date: Jul. 15, 2010

(54) METHOD FOR CUTTING A PLANAR PRINTING PLANE

(75) Inventors: Didier Dubesset, Villejuif (FR); Eric Vilain, Athis-Mons (FR); Bart Vanhauwaert, Rotterdam (NL)

Correspondence Address: YOUNG & THOMPSON, 209 Madison Street, Suite 500, Alexandria, VA, 22314, US

(73) Assignee: GRAFITRONIKS, Vitry sur Seine (FR)

(21) Appl. No.: 12/666,791

(22) PCT Filed: Jun. 26, 2008
(86) PCT No.: PCT/EP08/58145

§ 371 Date: Dec. 24, 2009

(30) Foreign Application Priority Data
Jun. 28, 2007 (FR) 0704691

(51) Int. Cl. B26D 5/32

(52) U.S. Cl. 83/13

(57) ABSTRACT

A method for cutting a planar printing plane. The method belongs to the field of cutting a planar printing plane, such as a sheet or a plate, following a pattern previously printed on the printing substrate. The method includes: detecting (155) at least one sequence of points characteristic of the geometry of a cutting outline on the basis of cutting marks; allocating (156) each detected characteristic point to at least one cutting outline; searching characteristic elements (outline edge, outline corner) of the outline on the basis of the characteristic points; and translating (164) the cutting outline into vectorial information for generating a cutting program of at least one cutting outline.

### TECHNICAL FIELD OF THE INVENTION

The present invention relates to a method for cutting a flat print medium. It belongs to the field of cutting a flat print medium, such as a sheet or a plate, around at least one pattern previously printed on this print medium.

### STATE OF THE ART

In the printing field, it is known to print a plurality of patterns on a flat print medium, then cut this print medium around the patterns to separate them from one another. The term “flat print medium” should be understood to mean a print medium in plate form likely to exhibit a natural strength, or a print medium in sheet form likely to be flexible, it being possible for such a sheet to be conditioned and handled in a roll. Such a print technique is notably applied to the field of photography or similar, such as for posters or other similar notices. For example, photographs or, more generally, patterns are printed in a plurality on the print medium by being distributed over the surface area corresponding to the front side of the medium. Commonly, these patterns comprise an outline of regular geometrical shape, notably rectangular, and are likely to be of the same size (dimension) or of respective sizes for one and the same print medium. Such patterns are also likely to include an outline of complex shape, such as including at least partially curved areas.

There is thus the general problem of the cutting of the print medium around the patterns. For this, cutting appliances are implemented, that are either integrated in the print machine or are separate from the latter.

For a description of the state of the art, reference should be made to the document FR-A-2.903.039.

In the state of the art, also known is the document DE-A-34 33 288 in the name of BAUMANN which describes a cutting device and method based on a two-dimensional table with a carriage capable of displacing a video camera. In this state of the art, a complete image of the printed surface area is obtained by successive scans of lines in a direction X. When all the image has been acquired, each pixel of this image is analyzed so that when the pixel corresponds to an outline mark or inscription, it is taken into account to generate an element of a cutting program. It is therefore by analyzing each of the points of each of the outlines to be cut that the cutting programs that are then implemented are produced.

Such a state of the art provides great cutting accuracy even if the outlines are entirely arbitrary, but it demands a very slow reading of all of the medium, and it requires a knowledge of a very high number of points to obtain a good cutting accuracy.

### OBJECT OF THE INVENTION

To overcome the drawbacks in this state of the art, the present invention relates to a method for cutting a flat print medium around at least one pattern previously printed on this print medium with cutting marks associated with said at least one pattern, the method being of the kind in which a cutting learning step is carried out by detection of cutting marks and a step for producing a cutting program for said at least one pattern is carried out, said program being subsequently executed by a cutting machine.

The method consists in:
detecting at least one sequence of points characteristic of the geometry of at least one cutting outline on the basis of the cutting marks;
assigning each characteristic point detected to at least one cutting outline;
searching for the characteristic elements (outline edge, outline corner) of said outline on the basis of said characteristic points, then
translating the detected cutting outline into vector information for displacement of a cutting tool to generate said program for cutting at least one cutting outline.
   According to one aspect of the inventive method, the cutting outline being of polygonal shape, it consists in:
determining the orientation of at least one first edge of the outline by detection of at least two characteristic points;
determining an edge adjacent to a preceding edge detected and detecting at least one characteristic point of said adjacent edge.

According to one aspect of the inventive method, it consists in determining at least one origin point of at least one path for detection of characteristic points of determined dimensions on the basis of configuration data and/or the detection of a characteristic element of the printed medium such as an edge or a corner of the medium.

According to one aspect of the inventive method, the outline providing at least one determined internal margin with the useful printed internal surface area of the pattern, to detect a characteristic point, it consists in determining said path for detection of characteristic points in the internal margin provided and detecting in the path a transition of a detection characteristic, such as the print color or brightness between the margin and the printed mark.

According to one aspect of the inventive method, it comprises a step for detecting a corner by means of the detection of at least one characteristic point on a next edge adjacent to the preceding detected edge by executing a search for characteristic points in the margin inside said preceding detected edge.

According to one aspect of the inventive method, to acquire at least one characteristic point of an outline, it consists in determining said path for detection of characteristic points in the internal margin of said outline by means of path segments of predetermined dimensions to reduce the acquisition time on the basis of cutting outline format data.

According to one aspect of the inventive method, in which the relative orientation of the adjacent edges is predetermined, it consists in associating the known relative orientation of the edge currently being detected with the determined absolute orientation of the preceding detected edge to determine the direction of the internal margin and with the detection of a characteristic point on the edge currently being detected to deduce therefrom the directing coefficients of the straight line representative of the edge currently being detected.

According to one aspect of the inventive method, if a characteristic point is detected on a preceding detected edge in an outline, a step for confirming and/or reducing the uncertainties on the directing coefficients of said straight line representative of the preceding detected edge is executed.

According to one aspect of the inventive method, it consists in determining the path for detection of characteristic points of at least one cutting outline so as to progress in a first direction by acquiring the cutting outlines one after the other:
by choosing an origin point of the path for detection of characteristic points of a new outline by progressing in said first direction of the printed medium; then
when an extension limit of the printed medium in said first direction has been reached, in choosing a new origin point at the start of said first direction beyond the extension in a second direction of the detected outline that represents the smallest extension in said second direction out of the outlines detected in the preceding progression in said first direction as long as an extension limit in said second direction has not been reached and in reiterating the progressing path so as to acquire at least one new outline not yet detected.

According to one aspect of the inventive method, it consists in determining the path for detection of characteristic points of all the cutting outlines arranged along a first direction then, when the end of the extension of the first direction is reached, in provoking a progression of the path in a second direction, then in resuming the sequence for detection of the characteristic points of the cutting outlines arranged in said first direction and in repeating the operation until the end of the extension of the printed medium in the second direction is reached.

According to one aspect of the inventive method, when the printed medium is bigger in said second direction than the extension in this direction of a table receiving the printed medium, it also comprises a step consisting, when the path for detection of characteristic points has reached the end of the extension of the table receiving the printed medium in said second direction, in controlling an advance of the printed medium on said table receiving the printed medium, then in executing a step for detection of a new selected origin position at the start of said second direction and over the remaining surface area of the printed medium that is not yet recognized; and in resuming the process for detection of the sequence of the characteristic points on the cutting outlines not yet fully recognized.

### DESCRIPTION OF THE FIGURES

The present invention will be better understood, and details emerging therefrom will become apparent, on reading the description that follows of exemplary embodiments in relation to the figures of the appended plates, in which:

FIG. 1 is a diagram explaining the main steps of one embodiment of the inventive method;

FIGS. 2 to 5 are diagrammatic views of parts of a printed medium to explain certain steps of the inventive method; and

FIGS. 6 and 7 are successive diagrams illustrating another example of the control method according to the invention.

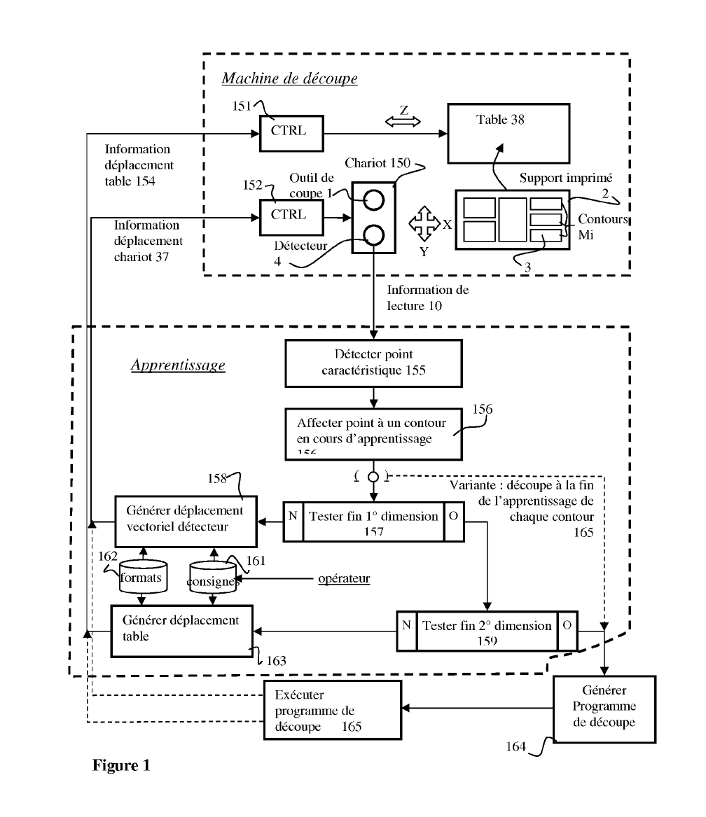

FIG. 1 shows a first exemplary embodiment of the method for cutting a flat print medium around at least one pattern previously printed on this print medium. In the method, a cutting machine is used that mainly comprises a table 38 equipped with a gantry that can receive a motorized carriage 150 under the action of a motor powered via a controller 152. The carriage 150 is mobile in a first dimension or direction, for example Y, whereas the gantry (not represented in FIG. 1) can be displaced in a second dimension or direction, for example X on the arrow-headed cross of FIG. 1. A printed medium 2, for example consisting of a sheet of paper of large dimensions, aligned in the directions X and Y of the table, and the front side of which has been printed 3, is arranged on the table 38. Hereinafter in the description, the term “dimension” may indicate a direction or an extension along this direction.

The table 38 is equipped with means for securing, removably and without making folds, the printed medium 2 relative to the movement of the gantry and of its carriage 150. Particularly when the printed medium 2 has a second dimension X greater than the corresponding dimension of the table 38, provision is made for the table 38 to be provided with motorized means under the control of a controller 151 to advance and/or retract the printed medium 2 at least by a fraction of the second dimension X, so as to process all of the surface area of the printed medium 2 in a number of passes or phases. To this end, the controller 151 makes it possible to power, in a controlled manner, a motor for advancing, according to the bi-directional arrow Z, the printed medium when it is fixed relative to the table and control the mean for fixing, removably and without making folds, the printed medium 2.

Such a cutting machine, known from the state of the art, executes the cutting of the printed medium 2 using a cutting tool 1, borne by the carriage 150. As has been described above, the printed medium 2 carries images or patterns such as the pattern 3, and that are arranged and distributed over the printed medium 2 in arbitrary places; in other words, to implement the method, there is no need to know “a priori” the dimensions, shapes and arrangements of the patterns.

It is known to have a cutting computer file associated with the print file previously used to produce the printed medium with patterns such as the printed pattern 3. However, and above all for printed media of large dimensions, the cutting files that were known in the state of the art do not make it possible to ensure accurate and lossless cutting of the printed patterns 3.

It has therefore been proposed to add around the printed patterns such as the pattern 3, outlines such as the outlines Mᵢ that are formed by solid or broken lines around the area containing each pattern such as the pattern 3.

The outlines are thus defined by cutting marks that are of two different kinds:
a first kind of cutting mark consisting of local simple marks used to define a characteristic element of the cutting outline such as an edge or a corner;
a second kind of cutting mark consisting of a solid continuous line completely surrounding the area occupied by the printed pattern 3.

The method makes it possible to recognize, in the absence of any “a priori” knowledge of areas of the printed medium 2 to be cut, a cutting outline by learning using a reading of the cutting marks performed when printing the printed medium 2.

### DESCRIPTION OF THE CUTTING MACHINE

The cutting machine represented in FIG. 1 is connected to a computer or controlling logic controller (not represented) that supplies it mainly with table displacement information 154 and carriage displacement information 37. To simplify the figure, third control information for the cutting tool 1 which indicates to a motor element (not represented in FIG. 1) associated with the cutting tool, an order to activate or deactivate the cutting according to the relative positions of the carriage 150 and its supporting gantry on the table 38 relative to the areas containing the printed patterns to be cut, is not represented.

Finally, the cutting machine produces a signal carrying read information 10 that is produced by a detector or reading means 4, attached to the carriage 150. The detector 4 preferably comprises an optical sensor, capable of detecting, by an appropriate setting, a contrast or a contrast transition between a light area and a dark area.

In one embodiment, a margin region positioned around the printed areas and mainly around the cutting marks previously printed on the printed medium 2 is used as a light area for setting the read detector 4. Similarly, the dark area set on the detector 4 is chosen on the print area of the cutting mark proper, for example a printed line provided as cutting mark or inscription.

When the carriage 150 describes a programmed trajectory that is indicated to it by the carriage displacement information signal 37 applied to the controller 152, the detector 4 detects any transitions between light areas and dark areas when the detector 4 crosses or follows a line as cutting mark or inscription.

When the detector 4 passes over other areas exhibiting other contrasts, the read detector 4 is not activated. By contrast, when the read detector 4 is activated, the relative position of the transition between a light area, characteristic of a margin preferably without printing, and a dark area, characteristic of a cutting mark or inscription, the coordinates of this position are inserted and stored in the read information 10 as coordinates of a characteristic point of a cutting outline as will be explained below.

Hereinafter in the description, paths for detection of characteristic points of printed marks around the cutting outlines are determined by controlling the X and Y displacements of the gantry and of the carriage supporting the read detector 4. The result of this is that, unlike in the state of the art, only a fraction of the points representative of the image of the printed medium 2 is analyzed which ensures high speed in executing the method.

FIG. 1 shows both learning means and the cutting learning step of the method that these learning means execute. Such learning means are produced on the basis of a computer that can execute a learning program that implements the method described, as will be explained below.

In FIG. 1, the cutting learning means, in which the main steps of the method have been represented, produce learning output signals or data that are supplied to a module 164 that can produce a cutting program, subsequently executed by the cutting machine described hereinabove.

Because of this, to cut a flat print medium 2 around at least one pattern 3 previously printed on this print medium, a cutting learning step by detection of cutting marks is implemented and a step for producing a cutting program subsequently executed by the cutting machine is carried out.

### Description of Step 1 of The Method: Learning

During the cutting learning step, the read detector 4 is driven by the carriage 150 along determined trajectories so that it can produce in the read information 10 sequences of characteristic points of the cutting marks so that it is possible to determine the geometry of a cutting outline on the basis of the sequence of the characteristic points detected.

To this end, the learning means execute a first step 155 for detection of a characteristic point. Such a characteristic point is obtained when the detector detects a correctly calibrated transition between a light area, a dark area and another light area corresponding to the margins that surround a dark line forming a cutting mark.

When a characteristic point of a cutting mark has been obtained in the step 155, the characteristic point is assigned to an outline currently being learned in a step 156.

When the sequence of characteristic points counts a determined number of characteristic points assigned to a cutting outline, it is then possible, as will be described later, to reconstruct the geometry of the cutting outline on the basis of just the characteristic points detected in the sequence of characteristic points.

When a characteristic point has been detected, according to tests that will be described later, the learning module or learning step makes it possible in a step 158 to generate a vector displacement of the read detector 4 by producing carriage displacement information 37 by means of a controller 152.

When a new characteristic point is detected in the read information 10 produced by the read detector 4, the learning loop continues and the sequence of characteristic points increases in each step 155 executed.

When a characteristic point has been assigned to an outline currently being learned in the step 156, a first test 157 is carried out to know whether the read detector 4, supported by the carriage 150 on the table 38, has reached the end of a first dimension of the printed medium 2, such as the width Y of the printed medium 2 arranged on the table 38. If the first dimension, such as the width Y, has been reached (Y; 157), a second test is carried out in the step 159 to known whether the read detector 4, supported by the carriage 150 on the table 38, has reached the end of a second dimension of the printed medium 2, such as the length Y of the printed medium 2, arranged on the table 38.

If the end of the second dimension on the table 38 has not been reached (N; 159), in a step 163, a displacement of the table 38 is carried out by producing table displacement information 154 that is supplied to the control input of the controller 151 which makes it possible to temporarily release the removable means of fixing the printed medium 2 on the table 38, and pull the printed medium 2 backward by a table length 38 so as to make it possible to analyze and process a new section of length of printed medium 2.

If the end of the second dimension has been reached (Y; 159), the method then goes on to the step for producing a cutting program in the step 164, which will be described later. With the cutting program being produced by the cutting program production module in the step for producing cutting programs, it is transferred to the module 165 for executing the cutting program that controls the X and Y displacements of the carriage 150 that drives the cutting tool.

If the end of the first dimension has not been reached (N; 157) in the reading of the printed medium 2 by the read detector 4, a carriage 150 displacement instruction or information must be calculated so that the carriage 150 describes a determined trajectory on the basis of the sequence of the characteristic points already determined in the step 155 or on the basis of initialization conditions prior to the first detection.

To this end, the generator of the information 37 for displacing the carriage 150 is capable of producing an instruction recognized by the controller to displace the carriage from the current point on the table 38 to a destination point, for example defined by its coordinates relative to the current point where the carriage is located. Such information 37 is of the kind:
RELATIVE_DISPLACEMENT dX, dY
   which indicates that the carriage must be displaced from the point where it is located, defined by its abscissa X and its ordinate Y, to a destination point that is located at an abscissa X′=X+dX, with dX being the displacement in the second dimension, and an ordinate Y′=Y+dY, with dY being the displacement in the first dimension.

While the carriage 37 is traveling from the current point (X, Y) to (X′, Y′), the read detector 4 is activated as soon as it encounters a cutting mark or inscription on the printed medium 2. Read information 10 is produced that interrupts the path of the carriage 150 and that indicates a new characteristic point (step 155) added to the sequence of the characteristic points.

If no characteristic point has been detected, the vector displacement generator 158, in the step for producing carriage displacement information 37, produces a new relative displacement instruction taking into account the fact that a new characteristic point has not yet been reached, so that the path of the carriage 37 is continued over a new path segment of determined dimensions.

Provision is naturally made for any configurable path, or path segments, to be programmed, and for the speed profile thereof to be adjusted if desired.

The steps or means for generating the vector displacement information (dX, dY) for the detector 158 or the table 163 also use two databases consisting of formats in a database 162 and setpoints in a database 161 so that it is possible to define the paths or path segments of the carriage 150 according to the teaching hereinabove. In particular, these databases 162 and 161 make it possible to determine for example the dimensions of a configurable path or path segment. In the case where the cutting marks or inscriptions are rectangles, for example, a database of standard rectangular cutting formats is used so that the displacement in (dX, dY) is of the order of the smallest common multiple between the formats, whether in length or in width, or both.

Moreover, the configurable paths or path segments are determined according to at least one strategy for scanning the surface area of the printed medium 2 which reduces the learning time to a minimum duration.

According to a first strategy that will be explained using FIGS. 3 to 5, provision is made for learning to be carried out by cutting outline by following the internal margin provided between the line of the printed cutting inscription or mark and the useful area for printing the pattern 3.

In this first strategy, any characteristic point detected is assigned to the cutting outline currently being learned unless it has been detected that the outline currently being learned is closed through the acquisition of a final characteristic point. The next characteristic point is then assigned to a new cutting outline being learned.

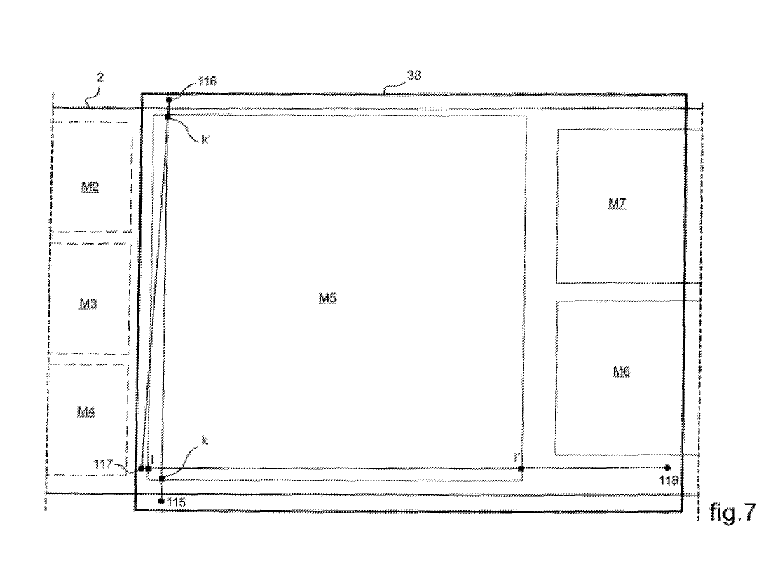

In a second strategy that will be explained using FIGS. 6 and 7, provision is made for learning to be carried out along a first dimension of the printed medium 2, then for an advance to be made in the second dimension and for an analysis in the first dimension to be reiterated, as has been described above. In this second strategy, a next characteristic point in the sequence of the characteristic points acquired in the step 155 may have to be assigned to an outline other than that which has received the assignment (step 156) of the preceding characteristic point.

The database 161 of the setpoints is fed by the operator of the cutting machine when he installs the printed medium on the table, for example, to indicate an analysis origin point that makes it possible to arrange the carriage with the detector 4 at a determined origin point to carry out the learning.

Similarly, the database 162 of the formats is fed by the operator on installation of the cutting machine or on opening printed medium cutting campaigns. The format database stores geometrical data and information on the geometry of the cutting marks and inscriptions or outlines, and on the particular arrangements of the lines and the margins surrounding the lines forming the cutting marks as will be explained later.

The format database 162 thus contains cutting inscription or mark identification and/or framing information. This information will be described later.

In a particular embodiment, provision is made for the insertion, between the step 156 of assignment of a characteristic point to a cutting outline during learning and the test 157 concerning the end of the first dimension, of a test of closure of an outline in a step 165 (represented between parentheses in FIG. 1, as a variant).

When the outline closure test is satisfied, the cutting outline is completely determined by the list of the characteristic points that have been assigned to it and the production of a cutting program is immediately executed in the step 164 for generation of a cutting program. When the cutting program on the basis of the detected finished outline has been generated and, where appropriate, executed, the control then returns to the test on the end of the first dimension. Obviously, the carriage 150 returns to a stored position before calling the step for producing the program for cutting the single detected closed outline.

Description of Step 2 of the Method: Translation into Cutting Program

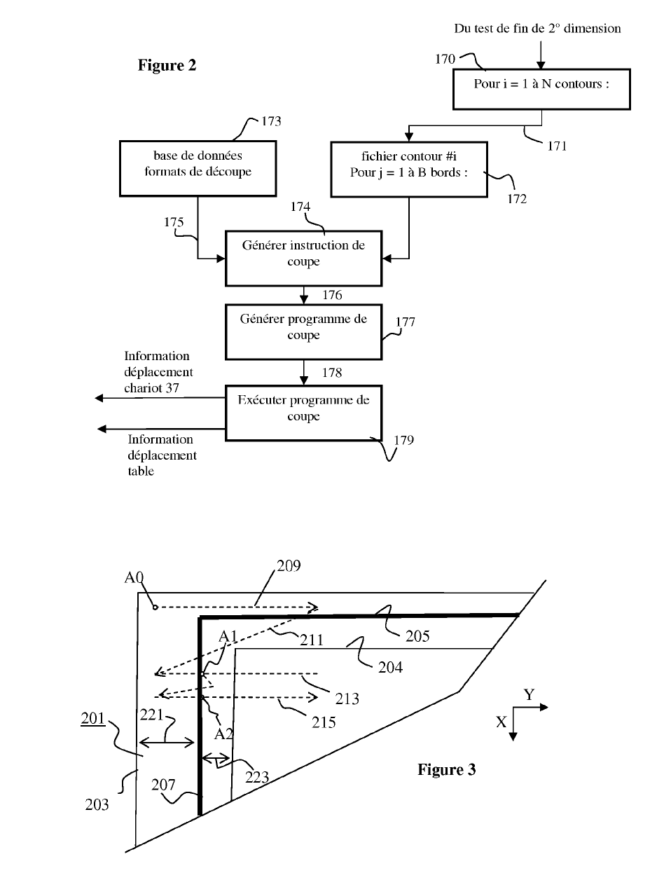

FIG. 2 shows a diagram for explaining the module capable of executing the step for producing a cutting program or the step 164 of the inventive method. In a step 170, a control loop is initialized over all the N outlines detected in the learning step (see FIG. 1) or in the case in which a group of outlines, such a group being able to be reduced to a single outline, is transmitted directly to the learning step.

Each cutting outline #i consists of a list of characteristic points that are assigned to it in the step 156 in the form of a cutting outline file #i. The file is read by the module 164 upon the transmission of the data from the learning module to the cutting program production module. The file characterizing a cutting outline #i can contain from 1 to B cutting edges, so that the cutting must be organized with B successive activation/deactivation commands and vector displacement commands for the cutting tool 1 mounted on the carriage 150.

A database 173, similar to the format database 162, contains the predetermined cutting formats that are stored by the operator on initializing the machine or a cutting campaign. The data affected by the outline file numbered #i are read 175, as are the data corresponding to the geometrical definition of the edge #j currently being read from the outline file 172.

In the step 174, a cutting instruction is generated which consists of a vector displacement order for the carriage and/or for the table intended for the controllers 151 and 152, followed by an order to activate the cutting tool, a vector displacement order while the cutting tool is active, then an order to raise or deactivate the cutting tool.

A cutting instruction is determined by a displacement of the carriage 150 supporting the cutting tool 1 from a cutting start point to a cutting end point along a path determined according to the edge #j detected in the outline #i. Particularly, when the outline #i is a rectangle, the edge #j is a straight segment and the cutting instruction is then a straight segment whose position relative to the edge #j is predetermined, for example within the internal margin of the cutting outline at a predetermined distance. The determination of the position of the cut relative to the cutting outline determined during learning is added to a cutting database.

When the cutting instruction corresponding to the reading of an edge from the outline file 172 has been executed, this instruction is passed 176 to a tool capable of adding the cutting instruction to a cutting program 177. The loop for translating the edges into cutting instructions for all of the outline file #i for all of its B edges 172 is executed. When the outline file #i has been fully analyzed so as to produce the appropriate sequence of cutting instructions, the loop i over all the outline files is incremented.

When the loop of the N outlines has been used up, the cutting program is then entirely available 178 and can be executed 179 by an appropriate processor associated with the cutting machine and which produces the sequences of carriage displacement information 37 and any table displacement information 154, as well as the orders to activate/deactivate the cutting tool 1 and that are passed to the controllers 151 and 152 and to the controller (not represented) of the cutting tool 1 on the carriage 150.

### First Read Strategy: “By Internal Margin”

FIG. 3 shows the top left corner of a printed medium 201 whose width 203 is arranged at the start of the table 38 of the cutting machine of FIG. 1. The carriage 150 positions the detector 4 over the point A0 arranged close to the edge of the printed sheet or medium 201. A cutting mark, consisting of a continuous line fully surrounding the area containing the printed pattern to be cut, is represented by the corner 205.

Moreover, the useful area 204 containing the printed pattern that has to be cut is also represented. Between the hypothetical area 204 represented in FIG. 3 and the cutting line 205, there is an internal margin 223 in which the brightness or contrast, or any other optical characteristics that can be detected by the detector 4 of the cutting machine, is determined as a light area for setting the transition contrast threshold for the read detector 4 (FIG. 1). Similarly, outside the cutting inscription 205 there is an external margin 221 which also presents a light background area that can be detected and recognized as such by the detector 4.

In the learning step, the acquisition of a sequence of characteristic points of the step 155 is started; carriage displacement information 37 is then generated for the controller 152 which produces a displacement of the detector 4 from the origin point A0 along the path 209. The origin point A0 is a point determined according to a configuration database (161; FIG. 1) and on the basis of the detection of a characteristic element of the printed medium such as a lateral edge of the medium or its corner. The determination of such an origin point of “A0” type is repeated on each new outline discovered in the cutting learning step.

The path 209 is determined by the format information in the database 162 and corresponds, in an exemplary embodiment, to the direction of the second dimension Y represented on the reference mark of FIG. 3. Once the path 209 has been completed, the carriage returns to the Y ordinate of the origin point A0 along the path 211, or any other path of the same kind, while being offset by a step in the direction of the first dimension X. On a new parallel path of the same length as the path 209, a path 213 makes it possible to encounter a characteristic point A1 on the first edge of the first outline encountered. The first edge is directed rather in the direction of the first dimension X of the cutting learning. The sequence of paths 209/211/213 . . . is repeated until the first characteristic point A1 is detected using the read detector (4; FIG. 1). The coordinates of the characteristic point are assigned to a first outline during learning in the step 156 (FIG. 1) and the control of the relative inclination of the first edge 207 on which the first characteristic point A1 has just been detected is executed. To this end, the detector vector displacement generator 158 of the learning means controls a displacement so that the read detector 4 is placed along a path 215 parallel to the paths 209 and 213 to capture or acquire a second characteristic point A2 on the edge 207.

When the cutting inscriptions comprise a polygon such as a triangle or a rectangle, data from two points A1, A2 makes it possible to completely determine the inclination of any edge of the outline like the first edge 207. Such a procedure can be executed for each edge of the outline during learning. If the polygonal outline is of known shape and the accuracy in the printing of the cutting marks is correct, there is no need to measure the inclination of the subsequent edges of the outline after measuring the inclination of the first edge 207. All that is needed is to add the angle between the two adjacent edges, in this case 90°, to know the absolute inclination of the next adjacent edge. The data from the two points A1 and A2 makes it possible to determine the coefficients a, b and c of the equation aX+by +c=0 which defines the direction of the analyzed edge. The read information (10; FIG. 1) contains the coordinates of the characteristic points that can be used to find or define the edges of the cutting outline.

Similarly, if the edge consists of an arc of circle, it is possible to obtain a correct definition of the arc of circle by the detection of three characteristic points.

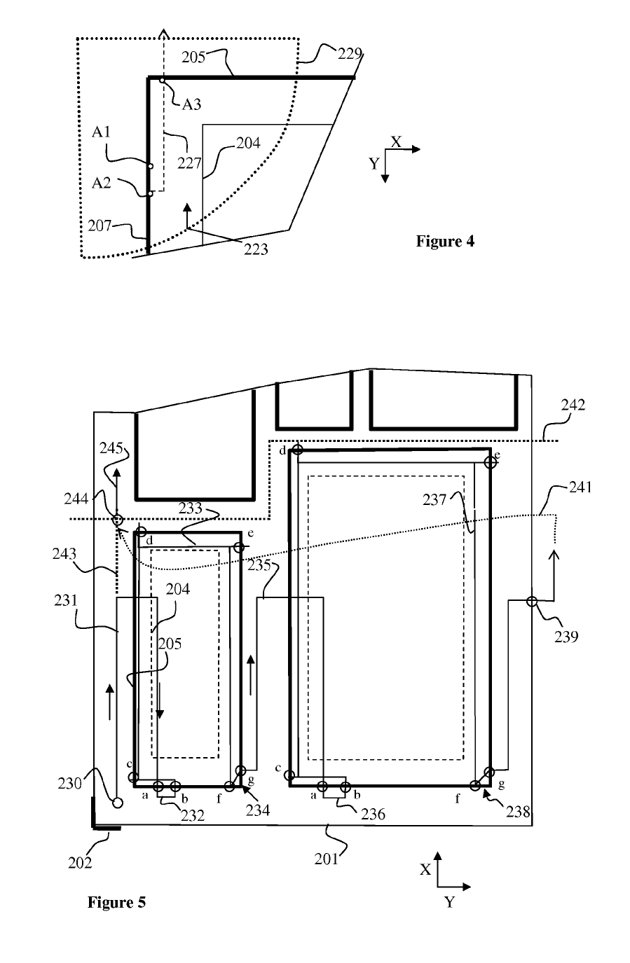

FIG. 4 represents a procedure for making it possible to detect a corner in a polygonal outline like a rectangular outline. The procedure for acquiring characteristic points described using FIG. 3 is continued, and the learning process is continued by ordering the carriage, through the carriage displacement information 37, to make a displacement along the path 227 which is performed along the first dimension in the direction of a return toward the ordinate of the origin point.

When a transition characteristic of a line of a cutting inscription is detected, the edge 205 is then detected by its characteristic point A3. Thus, it is possible, through the data from three points, or four points if the inclination of the edge 205 is not predetermined in the format database, to completely define a corner 229 formed by the intersection of two edges 207 and 205.

From the detection of the first characteristic point of an outline, the sequence of the characteristic points is detected in the internal margin 223 of the outline 207, 205. This characteristic makes it possible notably when following in parallel an edge, such as the edge 207, to be assured, in the case of a convex polygonal outline such as a rectangle, of detecting the first characteristic point of an edge, such as the edge 205, adjacent to the edge 207 detected previously.

Similarly, the data from the edge 207 and from the first point A3 of the second adjacent edge 224 makes it possible to easily determine, in the case of a predetermined rectangular outline, the coordinates of the corner 229, in this case as X and Y coordinates relative, for example, to the origin point A0 of FIG. 3.

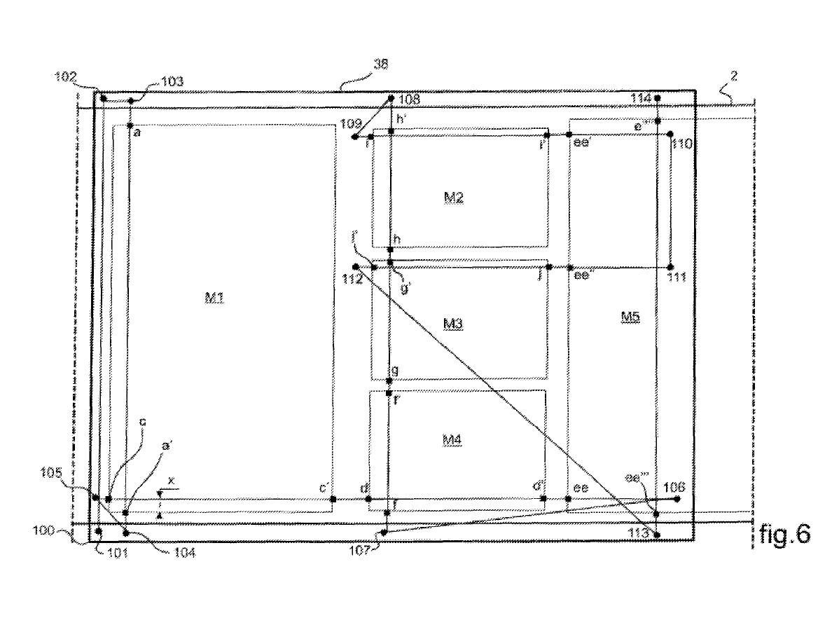

FIG. 5 shows an exemplary implementation of the method of this embodiment. The printed sheet or medium 201 is arranged on the table of the cutting machine in a position determined, for example, by a guide 202, and an origin point 230, of the same kind as the point A0 of FIG. 3, is determined on the bottom left corner in the drawing of FIG. 5. A first path 231, similar to the path 209, is then ordered so as to make it possible to acquire the two characteristic points a, b of a first edge 232 and its inclination. Then, the path is continued so that the point to the left c on the vertical edge is then determined, similar to the point A3 of FIG. 4, and the detector 4 is transferred along the vertical path in the internal margin 223 contained between the outline 205 and the useful surface area 204 of the pattern to be cut so that it is possible to then reach the characteristic point d of the top horizontal edge of the outline.

Similarly, once the characteristic point d of the top horizontal edge has been acquired, the characteristic point e of the right vertical edge of the first outline on the left in FIG. 5 is acquired and the detector 4 is brought to its origin abscissa X along the path 233. In this way, a rectangular outline is perfectly determined by the data from the two points a, b of the first horizontal edge 232, and from three characteristic points c, d and e, acquired respectively on the left vertical adjacent edge, the top horizontal edge and the right vertical edge of the first outline.

When the detector 4 continues the trajectory 233 in the internal margin area 223, a new characteristic point f is then detected on the horizontal bottom edge, so that a first characteristic point for the bottom right corner 234 is acquired, and which makes it possible to confirm and/or make more accurate the determination of the orientation of the bottom edge obtained using the two points a and b in 232. Similarly, the point g of the corner 234 on the right vertical edge of the first outline can be acquired when the detector 4 completes the crossing of this edge on the continuation 235 of its trajectory. Knowledge of the two characteristic points f and g of the corner 234 makes it possible to confirm and/or make more accurate the specification of the cutting outline on the left on the printed medium of FIG. 5.

With the first outline having been acquired, as described using FIG. 1, it is possible either to order a cutting of the acquired outline, or to wait for all the outlines or a group of outlines to have been acquired.

The process described for the first outline is then repeated by executing a displacement of the carriage 37 along the trajectory 235. The new origin point of ‘A0’ type (FIG. 3) consists of the last characteristic point of the fully detected preceding outline. As for the detection of the sequence of characteristic points for the first outline, the path for detection of characteristic points continues with the detection of a pair of characteristic points a, b for determining the position and the orientation of the first horizontal edge 236 of the second outline, to the right on the printed medium 201. In the same way as for the first outline, a characteristic point is acquired in succession for each of the remaining edges, namely c for the left vertical edge, d for the top horizontal edge and e for the right vertical edge.

In the same way, the path for detection of characteristic points is determined along the path 237 to return to the first bottom horizontal edge so as to acquire the characteristic points f and g of the corner 238 in order to also produce a confirmation and/or an improvement of the accuracy of the outline. The second rectangular outline is then fully acquired.

When the second rectangular outline is acquired, the process for acquisition of a new rectangular outline is then repeated and the detector 4 is displaced on its carriage so as to follow the path 239 on which the edge of the printed medium 201 is detected. The end of the first dimension Y or end of the extension of the printed medium in the first direction Y has thus been detected in the learning step.

Once the end of the first dimension Y has been detected in FIG. 5, the test (159; FIG. 1) of the end of the second dimension X is executed so that, if the end of this second dimension in the direction X of the reference mark of FIG. 5 has not been reached, a new origin point 244 of ‘A0’ type (FIG. 3) is determined which is situated at the same Y ordinate as the first origin point 230 and whose X abscissa in the direction of the arrow 241 represented in FIG. 5 is determined on the abscissa of the smallest detected outline. With the new origin point 244 having been acquired, it is then possible to continue the acquisition 245 of the other outlines printed on the printed medium 2. It will be noted that on each repeat of an ‘A0’ type origin point, the surface area to be analyzed in the learning step is limited by the boundary 242 corresponding to the surface area already analyzed. The path for detection of characteristic points is thus made to progress over all of the surface area of the printed medium.

### Second Read Strategy: “by Scanning in Two Dimensions”

In FIG. 6, the operator places the print medium 2 on the supporting device 38. This operation is preferably performed by covering the supporting device 38 as much as possible with the print medium 2, by taking care to ensure that the patterns to be cut are best positioned within the reading and cutting surface area covered by the possible displacements of the reading means 5 and of the tool 1. In the exemplary embodiment illustrated, the device 38 supporting the print medium 2 is arranged as a table and only the reading means 5 can be displaced to detect the read information 10. According to variants that are not represented, the table can be mobile in displacement and can be maneuvered by the mobility means 29, in isolation or together with the reading means 5, or else the device 38 supporting the print medium 2 has a vertical extension and is mobile whereas the reading means 5 are fixed. Other variant embodiments of the device 38 supporting the print medium 2 and/or of the modalities of relative mobility between the print medium 2 and the cutting tool 1 and/or the reading means 5 are possible without contravening the rules defined for the modalities for generation of the cutting program 6 and the reading program 32.

The operator inputs the setpoint information, and more particularly in the case of the example, the formats of the patterns M1, M2, M3, M4, M5, M6, M7 to be cut. Such setpoint information is likely to be already present in memory and is input only if needed according to the patterns to be cut. Incidentally, the operator may select formats that the reading means 5 are likely to detect and/or their number. The latter operation is not mandatory, the learning means and the recognition means, associated with the comparison means, being able to detect the different patterns to be cut whose setpoint information is stored by the memory means of the device. However, this operation makes it possible to reduce the number and the density of the calculation operations that the device has to perform to identify the different formats of the patterns to be cut. The set of information input by the operator forms a database relating, for example to formats, geometrical conformations, thicknesses of lines edging the patterns to be cut, even potential separation distances between this line and a pattern or between two adjacent patterns or inscriptions, without prejudicing a cutting program 6 and a reading program 32 to be generated during a learning cycle. The information in the database is used not only for dimensional accuracy when cutting the patterns, but also to drive the displacement means 31 while avoiding using the learning means 9 when that is not necessary to identify and locate the pattern or patterns to be cut.

On completion of a trajectory traveled by the reading means 5 in association with the use of the learning means 9, the device can compare the read information 10 previously recognized as revealing the presence of an inscription and/or a pattern with setpoint information 15, 19, d, e, D, C, to deduce therefrom one or more appropriate trajectories according to the inscriptions and/or patterns identified and to deduce therefrom the need or otherwise to use the learning means 9 together with this or these new trajectories.

The operator provokes a start of read cycle able to generate a read program and at the same time a cutting program. This operation is likely to be performed from a validation key or other similar on/off control device.

A first trajectory 101-102 is by default close to an origin point 100, for example a start point 101 situated at a distance of the order of 10 mm from the origin point 100. The position of this start point 101 is likely to be programmed in advance by the operator. An effort is made to detect the edges of the patterns (images) and/or possibly of a frame surrounding them. The possible detection of a frame provokes a command to cut parallel to the edges of this frame by a value that can be programmed by the operator. The cutting is likely to be done at the internal or external boundary of the frame, or at any distance from the pattern inscribed within this frame. Such a cutting parameter is likely to be input and/or selected in advance by the operator. This first trajectory is carried out at least along all of a dimension of the print medium or at least along the greatest dimension of a pattern and/or of an inscription likely to be detected and whose format has previously been stored, as targeted above.

In the case where the first trajectory 101, 102 does not reveal reading information relating to an inscription, the driving means generate read vector information to provoke a displacement of the reading means 5 along a second trajectory toward the point 103. This read vector information 34 relates to a pitch and/or a direction that has been previously programmed, such as from an input and/or a selection made by the operator, and the learning means 9 are not used.

Then, the driving means 30 generate read vector information 37 to provide a displacement of the reading means 5 along a third trajectory toward the point 104, the learning means being used. In this displacement of the reading means 5, read information items a and a′ are detected by the reading means 5, analyzed by the learning means 9 and the recognition means 11 associated with the comparison means 14, 18. The device deduces the position of the point 105. This point 105 is situated between the first trajectory and the edge of the device 38 supporting the print medium 2, and is situated between the areas in extension of the points corresponding to the read information items a-a % A parameter x is likely to be input and/or selected in advance by the operator to position the point 105 relative to the point a, and therefore relative to the edge of the pattern to be cut.

With the point 105 having been deduced, the driving means 30 generate read vector information 34 to provoke a displacement of the reading means 5 along a fourth trajectory toward the point 105. By default, the learning means 9 are not used, but the operator can order them to be used from means 39 for deliberately applying the learning means 9. Then, the driving means generate read vector information 37 to provoke a displacement of the reading means 5 along a third trajectory toward the point 106, the learning means 9 being used. In this displacement of the reading means 5, read information c, c′, d, d′ e and e′ are detected and analyzed by the learning means 9 and the recognition means 11 associated with the comparison means 14, 18. The format of the pattern M1 is identified, and a dimension of the pattern M4 is identified. Moreover, the read information e, e′ reveals the presence of a pattern M5 partially situated on the device 38 supporting the print medium 2.

It will be noted that, from a single detected dimension of a pattern and from setpoint information relating to the potential format and/or to the number of the patterns, their position and/or their distribution on the print medium can be deduced by the learning means 9 and the recognition means 11 associated with the comparison means 14, 18. It follows that calculation operations are again spared and that the reading process can be accelerated without affecting the generation of the cutting program 6 deriving from the learning means 9.

With the reading means 5 having covered a dimension of the print medium 2 limited to a dimension of the supporting device 38, the learning continues according to the modalities similar to the technique that has just been described:
*) toward the point 107 without learning,
*) toward the point 108 with learning and detection of read information f-f, g-g′ and h-h′ respectively revealing the position and a dimension of the patterns M3 and M2 and of the other dimension of M4,
*) toward the point 109 without learning,
*) toward the point 110 with learning and detection of read information ii′ revealing the other dimension of the pattern M2 and ee′ revealing the presence of the pattern M5,
*) toward the point 111 without learning, deduced from the knowledge of the first dimension of M2,
*) toward the point 112 with learning and detection of the read information e, e′ relating to M5, and j-j′ revealing the other dimension of the pattern M3,
*) toward the point 113 without learning,
*) toward the point 114 with learning and detection of the read information ee′″-ee″″ relating to M5.

All of the surface area of the print medium 2 accessible to the displacement means 31 of the reading means 5 having been covered, the cutting program 6 is generated and the cutting of the patterns M1, M2, M3 and M4 is carried out.

Since the pattern M5 is only partially detected, it is not cut.

In FIG. 7, the print medium 2 is displaced relative to the supporting device 38. The pattern M5 partially detected is placed at the limit of the area that can be accessed by the reading means 5 and by the cutting tool 1. This area limit is likely to be reduced by a previously programmed value. Learning continues according to the modalities similar to the technique that has just been described:
*) toward the point 115 without learning,
*) toward the point 116 with learning and detection of read information k-k′ relating to a first dimension of M5,
*) toward the point 117 without learning,
*) toward the point 118 with learning and detection of read information M′ relating to the second dimension of M5. The learning cycle continues and the presence of the patterns M6 and M7 is detected and the pattern M5 is cut, in a manner similar to that described previously. The starting displacements of the reading means 5 that are performed without learning the read information 10, are provided for trajectories aiming to bring the reading means 5 toward a starting position of a trajectory from which the reading means 5 are displaced with learning of the reading information 10. It is advantageous for these starting displacements to be carried out without learning of the reading information 10 to enable the latter to move rapidly and to avoid unnecessary calculation operations. However, the device is preferably provided with means 39 of deliberately engaging the learning means 9 to enable the operator, if he wants, to order the learning, the recognition and/or the comparison of the read information 10 detected in these starting displacements.

The device can cut a pattern of which at least one of the dimensions is greater than the possible surface area covered by the cutting tool 1. Such a pattern format can be identified or not from the prior input of the setpoint information. The device can identify the fact that it is impossible to cut such a pattern in one cutting operation, that is to say, without having to displace the print medium 2 accordingly. This identification is, for example, made from the learning operation in itself and from the detection of the read information 10 revealing or not revealing an inscription 3, 4 along concurrent trajectories traveled by the reading means 5. Such an identification is preferably associated with the confronting of this read information with setpoint information relating to the format of the pattern to be cut. From the learning modalities similar to those that have just been described, such a pattern is detected and the partial cutting operation can be ordered. The medium is then displaced relative to the mobility means 29 of the cutting tool 1, and the learning continues according to modalities similar to those previously described to complete its cutting.

It will be noted that the learning and cutting modalities described in relation to FIGS. 6 and 7 are not exhaustive, but should be considered to reveal benefits obtained regarding the means implemented for such learning and for such pattern cutting. These modalities can be transposed to any patterns to be cut from an implementation of the learning means 9 associated with recognition means 11 and with comparison means 14, 18.

A method has thus been described for cutting a flat print medium around at least one pattern previously printed on this print medium. The method comprises the preliminary step of printing at least one inscription by means of a reading of this inscription associated with learning based on this inscription which enables learning information to be transcribed into vector information for controlling mobility-wise a cutting tool and/or a device supporting the print medium. The method comprises the association of at least steps consisting in:
a) performing a read of the surface of the print medium from a displacement of reading means and/or of the device supporting the print medium along this surface;
b) generating cutting data relating to inscription identification and/or framing information at least by learning on the basis of the read information;
c) generating, by transcription, a cutting program by identifying an outline (C) to be cut from at least any one of the operations consisting in identifying the inscription by comparing read information with the definition information and/or identifying the format by comparing read information with framing information on the basis of the cutting data; and
d) ordering the use of the mobility means from the vector information of the cutting program generated.

### Other Exemplary Embodiments

In other embodiments, a read detector 4 mounted on a mobile carriage 150 is not used. In an equivalent manner, a camera is used to take a two-dimensional image of the portion of the printed medium arranged on the table. As is known, this image comprises a covering of pixels arranged according to a stored two-dimensional table. Once acquired, the two-dimensional table is then analyzed on the basis of the method described hereinabove. The cutting outline learning step is executed by executing a path for detection of characteristic points from the pixels of the two-dimensional table representative of the image of the printed medium. For this, a numeric pixel value belonging to the path for detection of characteristic points is compared as the brightness of the color stored in each pixel of the table so as to detect the characteristic transitions indicating that the path for detection of characteristic points in the digital table of the 2D pixels has tallied with the image of a line of a cutting mark. A loop for acquisition of the characteristic points of the cutting outlines and for assigning them to a cutting outline, together with the two end-of-dimension tests described using FIG. 1 in particular, is then executed. The cutting program production step 164 is identical.

Particularly, the camera for taking a 2D image of a portion or all of the surface area of the printed medium can consist of a linear strip of electro-optical sensors arranged at the loading entry point of the cutting table 38. When the printed medium is loaded on the cutting table 38, while it progresses in front of the linear strip, the 2D image of the printed surface is acquired and the learning step can be executed. The time taken up by the execution of the paths of the carriage in the embodiment of the learning step of FIG. 1 in the strict sense is thus avoided, the digital analysis of a digital 2D image being much more rapid.

In other embodiments, the inclination of each of the edges is detected by the recognition of two characteristic points like the pair of points (a, b; FIG. 5). It is thus possible to recognize polygonal outlines in which the angular relationship between two adjacent edges is arbitrary.

In other embodiments, the cutting outline detected on completion of the learning step is compared to standard cutting outline formats. A cutting outline is then chosen that is corrected by using the cutting outline whose standard format is the closest to that which has been detected (or learned) and the corrected cutting outline is centered on the detected (or learned) cutting outline.

1. A method for cutting a flat print medium around at least one pattern previously printed on this print medium with cutting marks associated with said at least one pattern, the method being of the kind in which a cutting learning step is carried out by detection of cutting marks and a step for producing a cutting program for said at least one pattern is carried out, said program being subsequently executed by a cutting machine, characterized in that it consists in:
detecting (155) at least one sequence of points characteristic of the geometry of at least one cutting outline on the basis of the cutting marks;
assigning (156) each characteristic point detected to at least one cutting outline;
searching for the characteristic elements (outline edge, outline corner) of said outline on the basis of said characteristic points, then
translating (164) the detected cutting outline into vector information for displacement of a cutting tool to generate said program for cutting at least one cutting outline.

2. The method as claimed in claim 1, characterized in that, the cutting outline being of polygonal shape, it consists in:
determining the orientation of at least one first edge of the outline by detection of at least two characteristic points (A1, A2);
determining an edge adjacent to a preceding edge detected and detecting at least one characteristic point (A3) of said adjacent edge.

3. The method as claimed in claim 1, characterized in that it consists in determining at least one origin point (A0) of at least one path for detection of characteristic points of determined dimensions on the basis of configuration data and/or the detection of a characteristic element of the printed medium such as an edge or a corner of the medium.

4. The method as claimed in claim 1, characterized in that, the outline providing at least one determined internal margin (223) with the useful printed internal surface area (204) of the pattern, to detect a characteristic point, it consists in determining said path for detection of characteristic points in the internal margin provided and detecting in the path a transition of a detection characteristic, such as the print color or brightness between the margin and the printed mark.

5. The method as claimed in claim 4, characterized in that it comprises a step for detecting a corner by means of the detection of at least one characteristic point on a next edge adjacent (205) to the preceding detected edge (207) by executing a search for characteristic points in the margin (223) inside said preceding detected edge (205).

6. The method as claimed in claim 4, characterized in that, to acquire at least one characteristic point of an outline, it consists in determining said path for detection of characteristic points in the internal margin (223) of said outline by means of path segments (227; 231; 233; 235) of predetermined dimensions to reduce the acquisition time on the basis of cutting outline format data.

7. The method as claimed in claim 6, characterized in that, the relative orientation of the adjacent edges being predetermined, it consists in associating the known relative orientation of the edge currently being detected with the determined absolute orientation of the preceding detected edge (207) to determine the direction of the internal margin (223) and with the detection of a characteristic point (A3) on the edge currently being detected (205) to deduce therefrom the directing coefficients of the straight line representative of the edge currently being detected (205).

8. The method as claimed in claim 6, characterized in that, if a characteristic point is detected on a preceding detected edge in an outline, a step for confirming and/or reducing (234; 238) the uncertainties on the directing coefficients of said straight line representative of the preceding detected edge (232; 236) is executed.

9. The method as claimed in claim 4, characterized in that it consists in determining the path for detection of characteristic points of at least one cutting outline so as to progress in a first direction (Y) by acquiring the cutting outlines one after the other:
by choosing an origin point of the path for detection of characteristic points of a new outline by progressing in said first direction of the printed medium; then
when an extension limit of the printed medium in said first direction has been reached (239), in choosing a new origin point (244) at the start of said first direction (Y) beyond the extension in a second direction (X) of the detected outline that represents the smallest extension in said second direction out of the outlines detected in the preceding progression in said first direction as long as an extension limit in said second direction has not been reached and in reiterating the progressing path so as to acquire at least one new outline not yet detected.

10. The method as claimed in claim 1, characterized in that it consists in determining the path for detection of characteristic points (a, a′) of all the cutting outlines arranged along a first direction then, when the end of the extension of the first direction is reached (104), in provoking a progression of the path in a second direction, then in resuming the sequence for detection of the characteristic points (c, c′) of the cutting outlines arranged in said first direction and in repeating the operation until the end of the extension of the printed medium in the second direction is reached.

11. The method as claimed in claim 9, characterized in that, when the printed medium is bigger in said second direction than the extension in this direction of a table receiving the printed medium, it also comprises a step consisting, when the path for detection of characteristic points has reached the end of the extension of the table receiving the printed medium in said second direction, in controlling an advance of the printed medium on said table receiving the printed medium, then in executing a step for detection of a new selected origin position at the start of said second direction and over the remaining surface area of the printed medium that is not yet recognized; and in resuming the process for detection of the sequence of the characteristic points on the cutting outlines not yet fully recognized.

12. The method as claimed in claim 2, characterized in that it consists in determining at least one origin point (A0) of at least one path for detection of characteristic points of determined dimensions on the basis of configuration data and/or the detection of a characteristic element of the printed medium such as an edge or a corner of the medium.

13. The method as claimed in claim 2, characterized in that, the outline providing at least one determined internal margin (223) with the useful printed internal surface area (204) of the pattern, to detect a characteristic point, it consists in determining said path for detection of characteristic points in the internal margin provided and detecting in the path a transition of a detection characteristic, such as the print color or brightness between the margin and the printed mark.

14. The method as claimed in claim 3, characterized in that, the outline providing at least one determined internal margin (223) with the useful printed internal surface area (204) of the pattern, to detect a characteristic point, it consists in determining said path for detection of characteristic points in the internal margin provided and detecting in the path a transition of a detection characteristic, such as the print color or brightness between the margin and the printed mark.

15. The method as claimed in claim 5, characterized in that, to acquire at least one characteristic point of an outline, it consists in determining said path for detection of characteristic points in the internal margin (223) of said outline by means of path segments (227; 231; 233; 235) of predetermined dimensions to reduce the acquisition time on the basis of cutting outline format data.

16. The method as claimed in claim 2, characterized in that it consists in determining the path for detection of characteristic points (a, a′) of all the cutting outlines arranged along a first direction then, when the end of the extension of the first direction is reached (104), in provoking a progression of the path in a second direction, then in resuming the sequence for detection of the characteristic points (c, c′) of the cutting outlines arranged in said first direction and in repeating the operation until the end of the extension of the printed medium in the second direction is reached.

17. The method as claimed in claim 3, characterized in that it consists in determining the path for detection of characteristic points (a, a′) of all the cutting outlines arranged along a first direction then, when the end of the extension of the first direction is reached (104), in provoking a progression of the path in a second direction, then in resuming the sequence for detection of the characteristic points (c, c′) of the cutting outlines arranged in said first direction and in repeating the operation until the end of the extension of the printed medium in the second direction is reached.

18. The method as claimed in claim 10, characterized in that, when the printed medium is bigger in said second direction than the extension in this direction of a table receiving the printed medium, it also comprises a step consisting, when the path for detection of characteristic points has reached the end of the extension of the table receiving the printed medium in said second direction, in controlling an advance of the printed medium on said table receiving the printed medium, then in executing a step for detection of a new selected origin position at the start of said second direction and over the remaining surface area of the printed medium that is not yet recognized; and in resuming the process for detection of the sequence of the characteristic points on the cutting outlines not yet fully recognized.
